(19) United States
(12) Patent Application Publication
(10) Pub. No.: US 2005/0246223 A1
(43) Pub. Date: Nov. 3, 2005

(54) Data collection, processing and analysis systems, such as for use in a food service environment

(76) Inventors: David Roth, Chicago, IL (US); Rick Bacher, Chicago, IL (US)

Correspondence Address: PERKINS COIE LLP;PATENT-SEA, P.O. BOX 1247, SEATTLE, WA, 98111-1247, US

(21) Appl. No.: 11/119,337

(22) Filed: Apr. 28, 2005

Related U.S. Application Data
(60) Provisional application No. 60/604,504, filed on Aug. 24, 2004.
(60) Provisional application No. 60/565,984, filed on Apr. 28, 2004.

(51) Int. Cl. G06F 17/60

(52) U.S. Cl. 705/10; 705/15

(57) ABSTRACT

Methods and systems for collecting and processing data related to food, beverages, and associated goods and services are described herein. In one embodiment, a method for obtaining consumer data relating to cereal includes providing a menu to a customer in a quick-serve restaurant setting. The menu can include at least one selection that allows the customer to choose two different, competitively-branded breakfast cereals from a list of competitively-branded breakfast cereals. The method can further include receiving a request from the customer for two of the competitively-branded breakfast cereals on the list. In response to receiving the request, the method can additionally include recording information related to the request in a database, and providing at least a portion of the recorded information to a third party user.

### CROSS REFERENCE TO RELATED APPLICATIONS

This application claims the benefit of co-pending U.S. Provisional Patent Application Ser. No. 60/604,504, entitled “METHODS AND SYSTEMS FOR PROVIDING FOOD, BEVERAGES, AND ASSOCIATED GOODS AND SERVICES IN A RETAIL ENVIRONMENT,” filed Aug. 24, 2004; and co-pending U.S. Provisional Patent Application Ser. No. 60/565,984, entitled “METHODS AND SYSTEMS FOR PROVIDING FOOD, BEVERAGES, AND ASSOCIATED GOODS AND SERVICES IN A RETAIL ENVIRONMENT,” filed Apr. 28, 2004; each of which is incorporated herein by reference.

This application is related to co-pending U.S. Non-Provisional patent application Ser. No. 11/078,686, entitled “METHODS AND SYSTEMS FOR PROVIDING FOOD, BEVERAGES, AND ASSOCIATED GOODS AND SERVICES IN A RETAIL ENVIRONMENT,” filed Mar. 11, 2005; and co-pending U.S. Non-Provisional Patent Application Serial No. [Attorney Docket No. 35766.8002US00], entitled “SYSTEMS AND APPARATUSES FOR PROVIDING ENHANCED MANAGEMENT OF FACILITIES OFFERING FOOD, BEVERAGES, AND ASSOCIATED GOODS AND SERVICES IN A RETAIL ENVIRONMENT,” filed Apr. 28, 2005; each of which is incorporated herein by reference.

### BACKGROUND

There are a wide variety of retail establishments at which consumers can purchase food to order. These include traditional “sit-down” restaurants as well as conventional “fast food” restaurants, not to mention grocery stores, supermarkets, and the like. While most grocery stores and supermarkets always carry a wide assortment of competitively-branded food products in their aisles, aside from beverages, restaurants rarely list two or more competitively-branded food products on their menus. Sit-down restaurants, for example, typically prepare meals from scratch and, as a result, their menus seldom list branded food products, much less competitively-branded food products. Furthermore, as a general rule, fast food restaurants only sell food under the franchise's brand. When fast food restaurants do offer foods under a different brand, this is typically done as a promotional or “limited time” offering only.

Occasionally, both sit-down and fast food restaurants will offer competitively-branded food products to their customers. Notwithstanding the typical liquor bar, however, these foods generally do not constitute core menu items. For example, while conventional sit-down or fast food restaurants may offer one or two different types of competitively-branded beverages to accompany a meal (e.g., Coke®, Pepsi®, etc.), they typically do not offer competitively-branded food products as the main course. Further, while conventional restaurants may offer one or two competitively-branded items as a dessert or condiment (e.g., Heinz® Ketchup versus A1 Steak Sauce®), they typically do not offer a wide range of competing products in these categories from which the customer can choose.

On or about Jun. 12, 2001, General Mills, Inc. opened the “Cereal Adventure” attraction at the Mall of America in Bloomington, Minn. The attraction, which has since closed down, was billed as a playful, interactive learning experience where kids could immerse themselves in the world of General Mills' cereals. Among the entertainment features, Cereal Adventure included “Cheerios® Play Park,” “Trixe Fruity Carnival,” and “Lucky Charms® Magical Forest.” In addition, at the “Wheaties® Hall of Champions,” visitors could pose for their own souvenir Wheaties box with their picture on it. The “Make Your Own Cereal” feature allowed visitors to create their own unique brand of cereal using General Mills' products, including creating the name of the cereal, box design, and contents. For a price, visitors could take their customized cereal home.

Kellogg's Cereal City USA™ in Battle Creek, Mich. is designed to entertain visitors while informing them about the cereal industry and Kellogg's products in particular. Cereal City is a combined museum, factory tour, and theme attraction that houses interactive exhibits, theaters, play areas, and a themed diner. For visitors who want a memento, they can take home a box of Kellogg's Frosted Flakes®) cereal with their photo on it. Cereal City also includes a restaurant that offers fast food in addition to desserts, such as a “Fruit Loops® Sundae.”

### BRIEF DESCRIPTION OF THE DRAWINGS

FIG. 1 is a perspective view of a Quick Service Restaurant (QSR) configured in accordance with an embodiment of the invention.

FIG. 2 is a flow diagram illustrating a method for providing competitively-branded food products in a single food category to customers in accordance with an embodiment of the invention.

FIG. 3 is a schematic diagram illustrating a suitable computer for employing aspects of the invention.

FIG. 4 is a schematic diagram illustrating a suitable system in which aspects of the invention may operate in a networked computer environment.

FIGS. 5A-5G illustrate a series of screen displays for selecting, ordering, and/or recording various combinations of competitively-branded food products in accordance with an embodiment of the invention.

FIGS. 6A-6D illustrate a series of screen displays for taking a customer order at a point-of-sale in accordance with an embodiment of the invention.

FIG. 7 is a flow diagram illustrating a routine for obtaining and/or mining customer point-of-sale data in accordance with an embodiment of the invention.

Note: The headings provided herein are for convenience only, and do not necessarily affect the scope or interpretation of the invention.

This disclosure contains material for which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

### DETAILED DESCRIPTION

In broad terms, the following disclosure describes various systems and methods for providing food and other products to consumers in a convenient, retail setting. Certain details are set forth in the following description to provide a thorough understanding of various embodiments of the invention. Other details describing well-known structures and systems often associated with food service establishments are not set forth, however, to avoid unnecessarily obscuring the description of the various embodiments. Further, those of ordinary skill in the art will appreciate that other embodiments of the invention may be practiced without at least some of the details described herein.

Overview

In one embodiment described in greater detail below, a system for providing competitively-branded food products to consumers includes a quick-service restaurant (QSR) that displays the products in their readily-recognizable, retail-sale containers. As used herein, the term “competitively-branded” generally refers to foods that fall into the same category (e.g., cereals), but are produced by competing manufacturers (e.g., Kellogg's and General Mills) and sold under different brand names (e.g., Cheerios®, Fruit Loops®, Chex®, etc.). In one aspect of this embodiment, the system enables and encourages customers to order unique combinations of competitively-branded cereals to suit their own particular tastes. The orders are prepared by an employee of the QSR who combines the selection together with one or more toppings in a convenient, carry-out bowl having a closeable lid. The consumer may then add milk and enjoy the cereal on the premises, or seal the container and take it to enjoy later.

A QSR configured in accordance with another embodiment of the invention has the look and feel of a residential kitchen complete with over-the-counter food cabinets. The cabinets can have glass fronts to display an array of competitively-branded cereal boxes. Graphically displaying the different cereal choices in this manner gives the customers visual reference cues that are more compelling than simply displaying raw cereal in see-through holding bins. (As explained below, cereal is provided in drawer or bins in the QSR, but these bins are behind the counter and not accessible or typically viewable by consumers.) Displaying the readily-recognizable cereal boxes to the customers sparks an immediate taste-association with the customer, and lets him or her know immediately what types of cereal are offered and what he or she can expect. Conversely, merely identifying “granola” as a generic menu item often leaves the customer wondering what type (i.e., what brand) of granola is being offered. Indeed, it is quite rare to see competitively-branded foods advertised by their retail-sale containers as the core menu items in a restaurant setting, and even rarer to see a menu that encourages ordering unique combinations of such foods.

The QSR can include a number of entertainment features often associated with cereal and/or the cereal-eating experience. For example, in one embodiment, the QSR can include one or more viewing screens (e.g., video screens) that show familiar “Saturday morning” cartoons for viewing by customers.

In another embodiment, the QSR can provide hot cereal to order. For example, employees can make hot cereal mixtures one batch at a time using a pan and induction burner. In addition or alternatively, a rice cooker or other device can be advantageously employed to make the hot cereal and maintain it at temperature until sold/served.

Various hot cereal dishes prepared by the QSR can include oats. For example, in addition to commercially available “quick-cooking” oats, the QSR can also prepare dishes with rolled oats that have been presoaked for a period of time in water. In one embodiment, the oats are mixed with water (and optional salt) in proportions similar to conventional preparation instructions (e.g., in proportions of about 1 part oats to about 4-5 parts water; such as about 1 part oats to about 4.6 parts water) and held for about 1 hour prior to usage. The relative proportions of the oats, water, and/or other ingredients, the hold time and the water temperature may be varied to achieve different results as desired. Presoaking the oats in this manner causes the oats to cook quicker and allows for the usage of longer cooking oats in this quick preparation setting.

The layout of the QSR is configured to permit efficient use of a small space, such that the induction burner, rice cooker, and/or dishwasher are effectively co-located. In this embodiment, customers move from a point-of-sale leftward to a central cereal mixing location. At this location, employees remove the selected cereals from storage bins located behind the counter, and mix the cereals together in an appropriate container. From here, the customers can view an arrangement of different toppings (both dry toppings and wet toppings) displayed on the counter, and can select one or more of the toppings for addition to the cereal order. After receiving their orders, the customers can proceed further leftward to add milk to the cereal at a milk station.

As explained below, the cereal is provided in various forms, not only hot or cold cereal in a bowl, but also blended with yogurt and/or other liquids to provide smoothies or other beverages, as well as combined to form cereal bars or snack mixes. Other products can include steamed dairy or soy milk to which flavoring and/or other products can be added. Products can also include various types of frozen dairy and non-dairy food items combined with cereal, such as frozen dairy and non-dairy products sandwiched between two bakery items that include cereal. Products can further include muffins and other baked goods made with various types of cereal. In addition, yogurt parfaits can include one or more layers of cereal between yogurt and fruit, and the yogurt may be frozen or replaced with ice cream. One or more different types of sweeteners may be added to cereal, including molasses, sugar, maple syrup and other flavored syrups, artificial sweeteners, honey, and so forth. Further, various toppings may be combined with the cereal, including bananas, raisins, candy, etc. Another menu item can include a “bowl” made with cereal, from which yogurt, ice cream and other food products (including more cereal) can be consumed before eating the bowl. Similar menu items include ice cream cone shells that are made from cereal. Still other menu items that may or may not include cereal can include custards, puddings, wraps (e.g., tortilla wraps), cookies, waffles, bagels, cakes, pies, pizza-like products, sandwiches, roll-ups, omelets, etc.

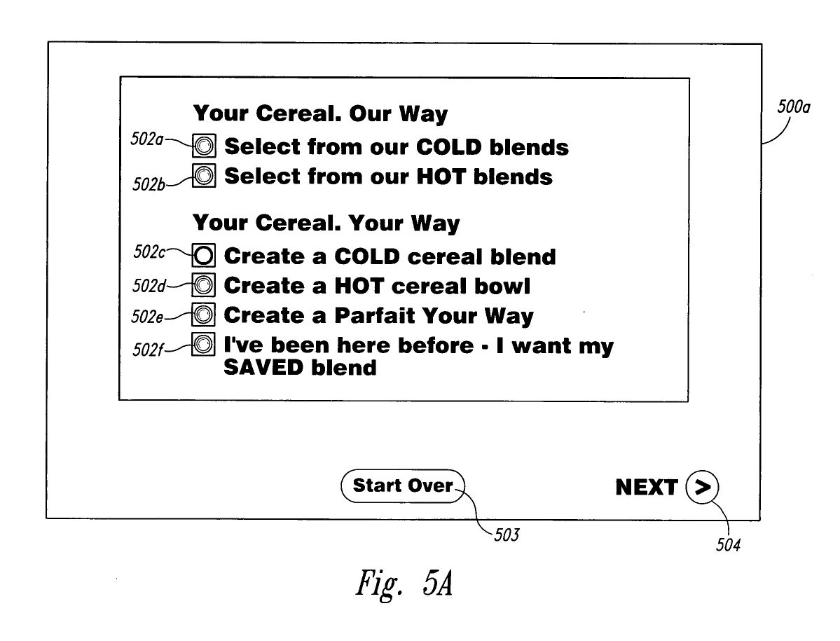

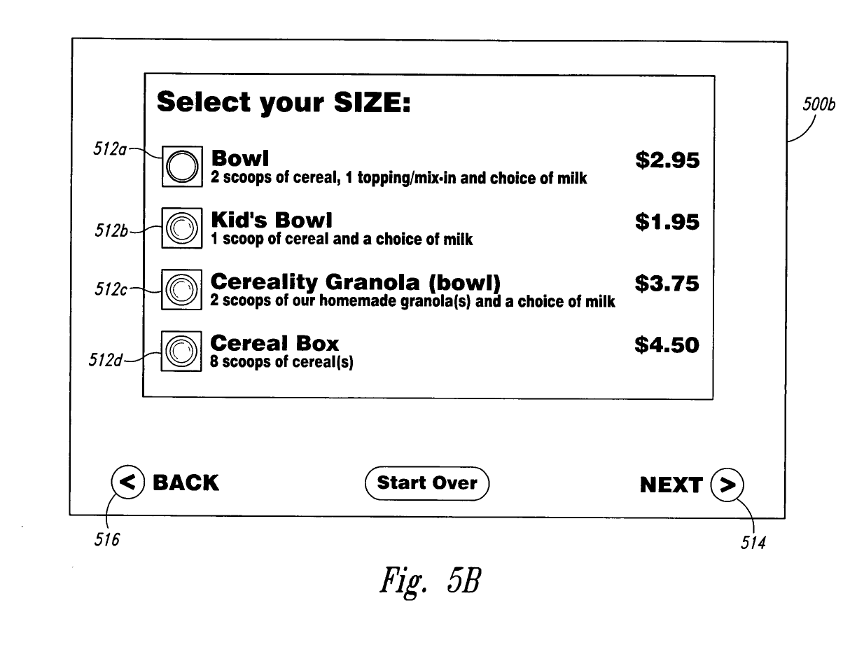

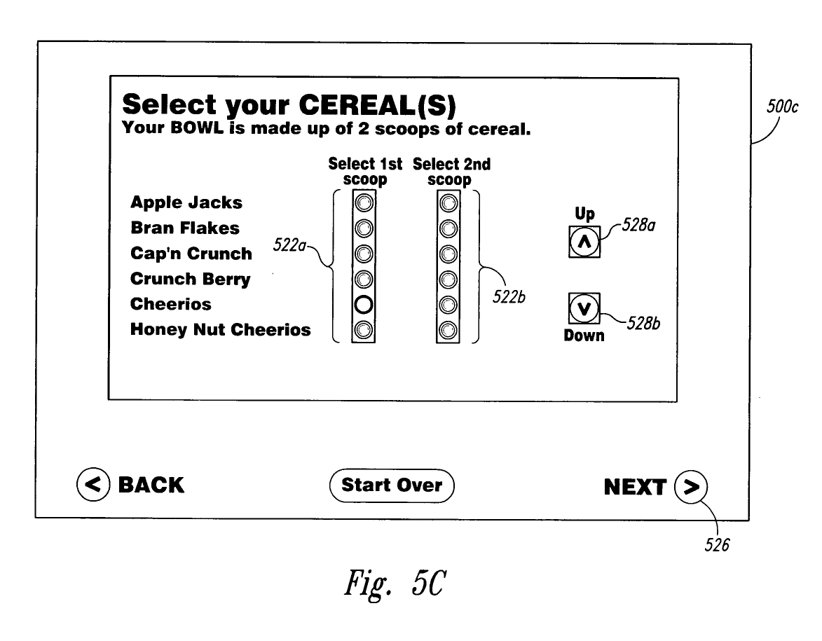

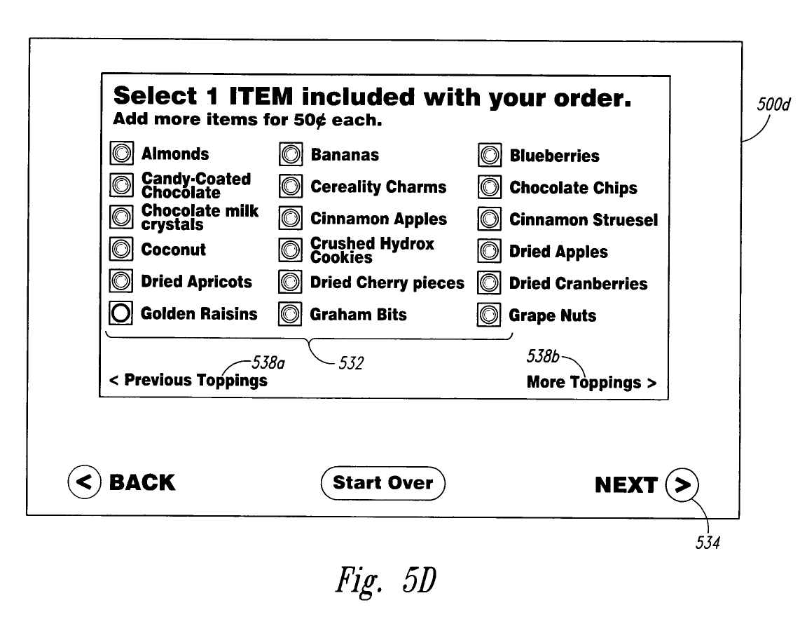

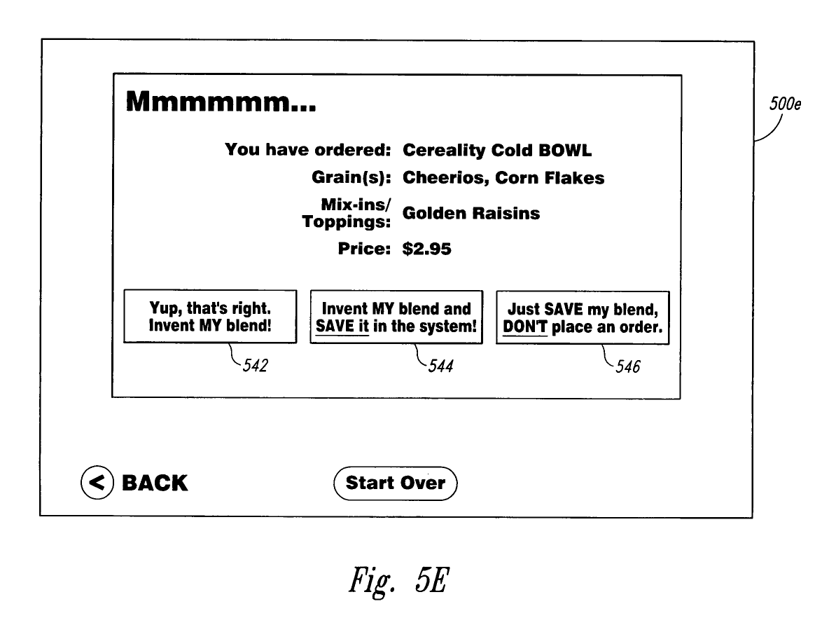

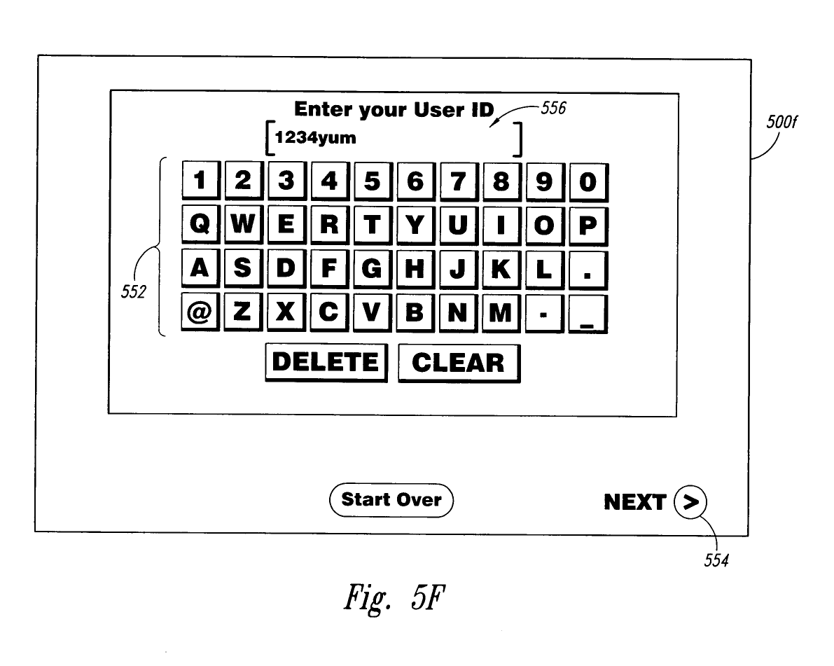

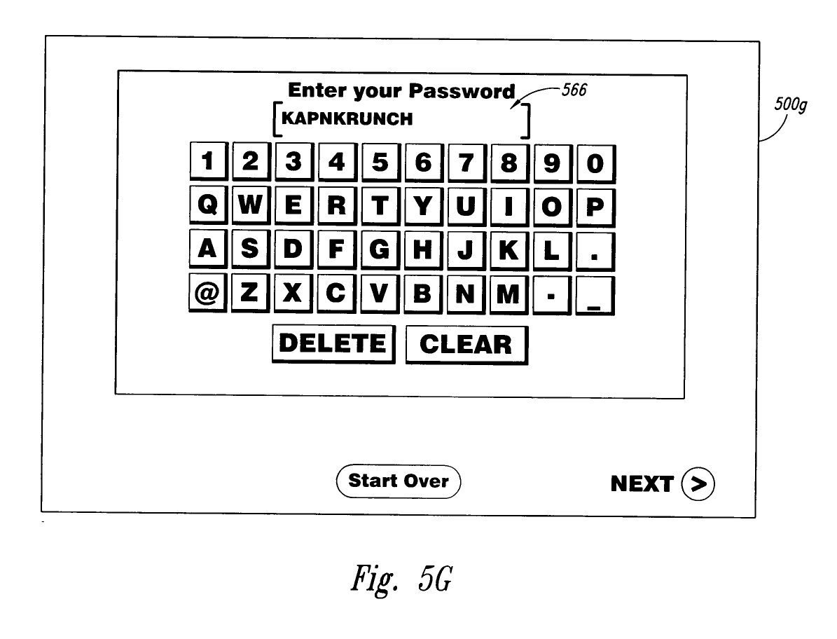

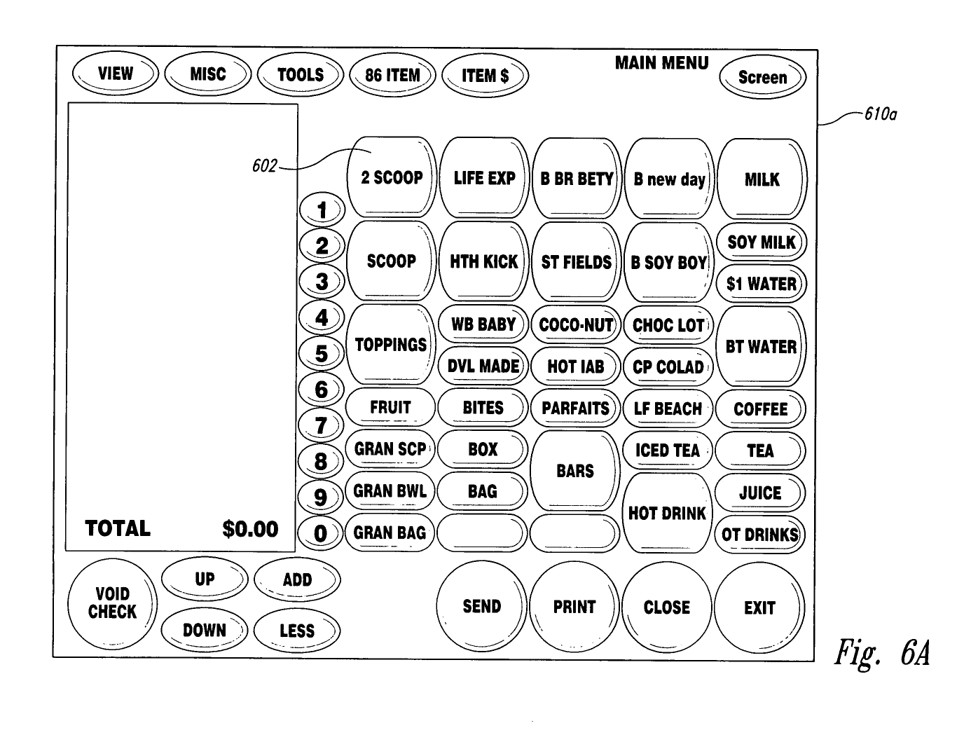

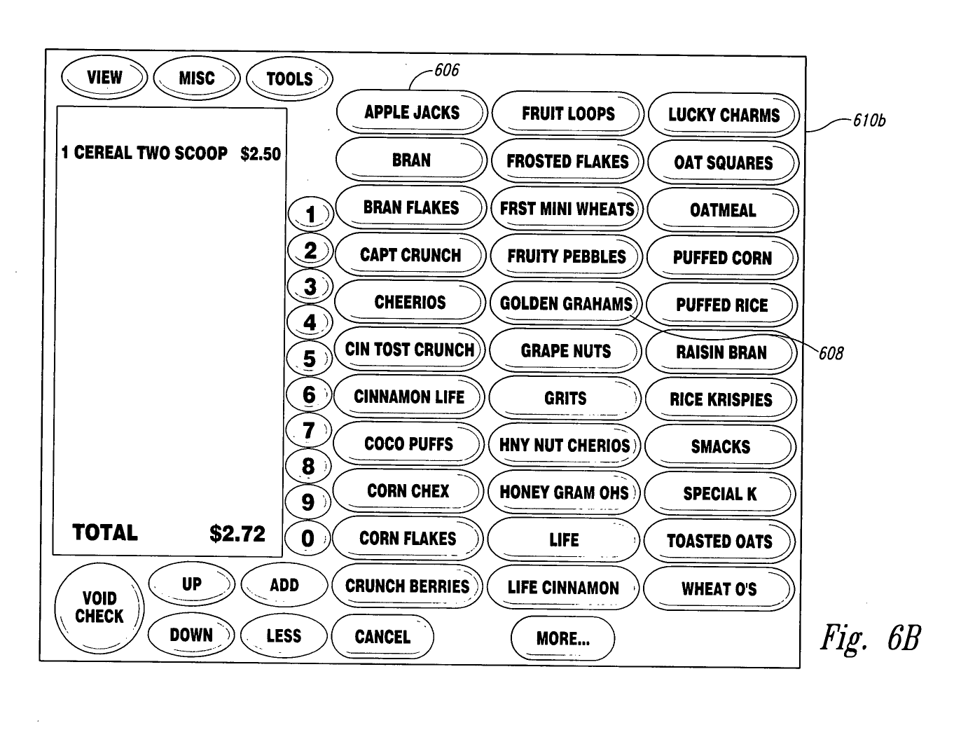

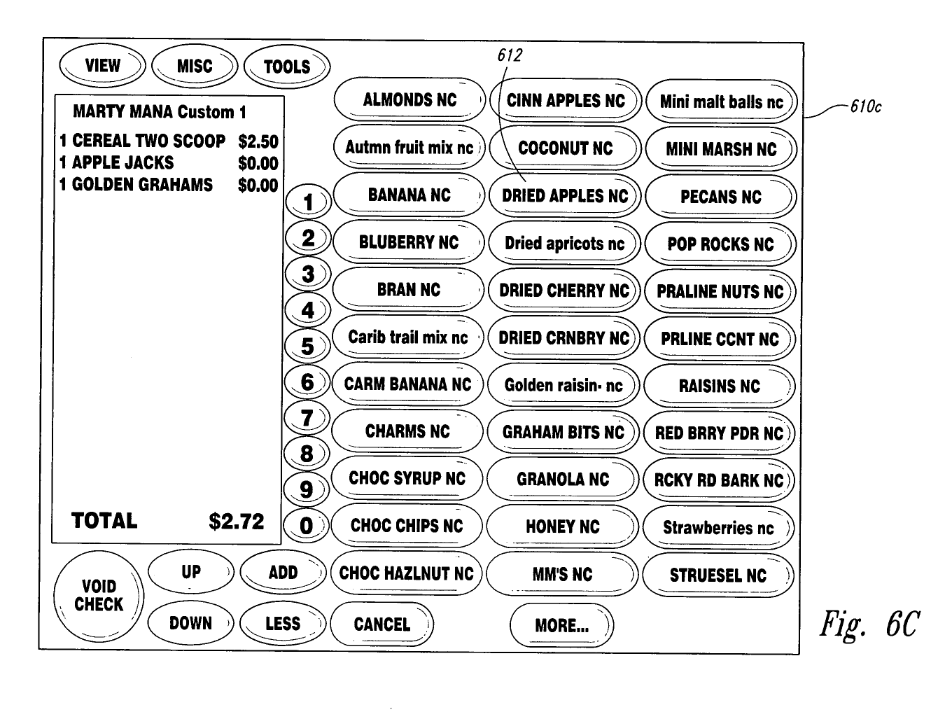

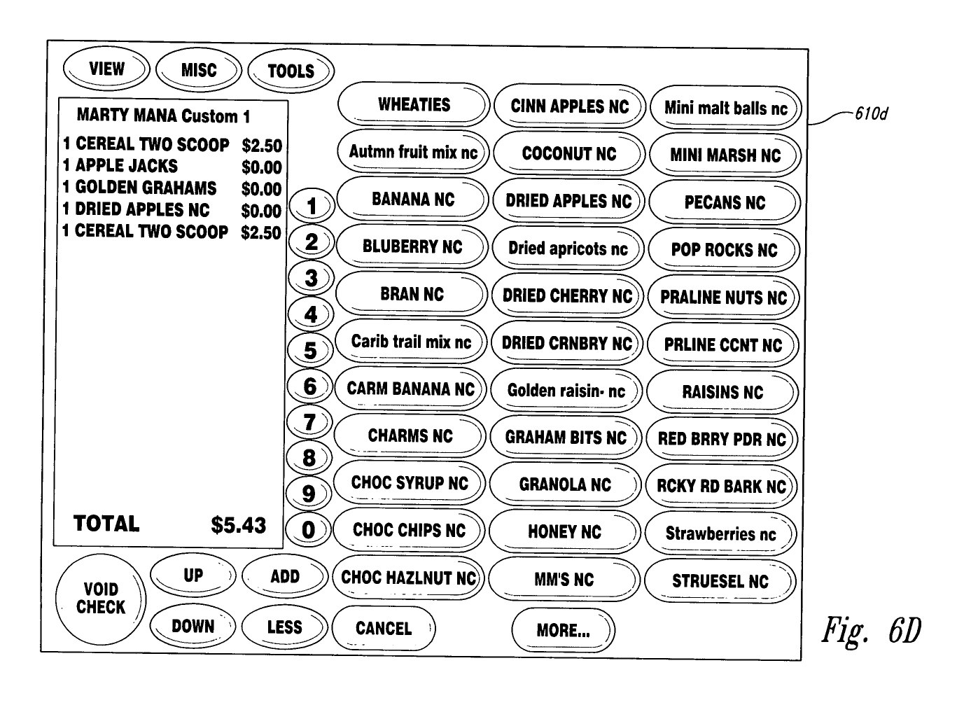

In a further embodiment, each QSR location can include one or more point-of-sale devices that gather information. This information may be repackaged and sold to manufacturers of various products or items sold at the QSR locations. Indeed, much of the information gathered reflects market research of spending habits of customers at each QSR. Information gathered at each point-of-sale can include the following:
types of cereal ordered, cereal combinations ordered, cereal combinations ordered for particular customers and/or particular customer demographics;
toppings added to cereal (e.g., whether fresh versus dried fruit is more popular);
brand loyalty (whether customers mix cereals of the same brand or not);
smoothies (“Slurrealities™”) and customer changes to predetermined smoothie recipes;
time-of-day habits;
volume purchased (e.g., bowls versus boxes of cereal versus cereal bars);
complementary sales (e.g., coffee);
use of frequent-user cards, stored-value cards, or the like;
repetitiveness (e.g., do customers order the same item or items each time?);
trials (e.g., at what rate does a new item break into the sales mix?);
seasonality (e.g., does the product sales mix vary throughout the year?); and
event purchasing (e.g., do external events impact product purchasing?)
   Many other types of information may be gathered, such as details on each sale, price of the sale, average sale per transaction per time of day, and so forth. Indeed, the point-of-sale device can gather information regarding each specific type of cereal or types of cereals added to a given order, the type of topping, the amount of each ingredient (cereal, topping, etc.), and so forth for every order. A suitable point-of-sale device can be any computer-driven point-of-sale device, and thus includes any type of computing device. Further, various aspects of the systems and methods described above can be implemented in a networked computer environment, such as the environment described in detail below with reference to FIGS. 5 and 6.

### EXAMPLE OF A SUITABLE RESTAURANT CONFIGURATION

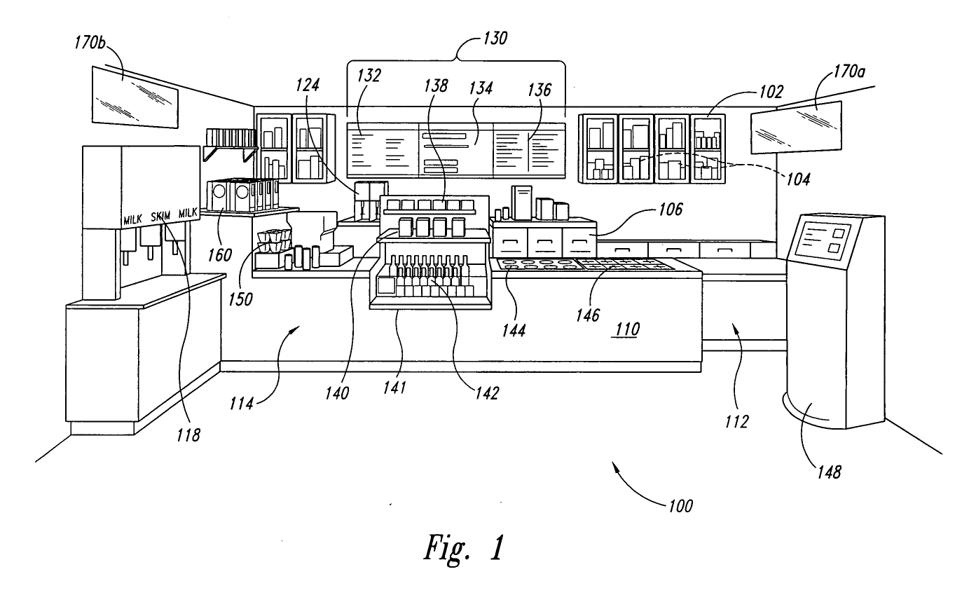

FIG. 1 is a front perspective view of a QSR 100 configured in accordance with an embodiment of the invention. The QSR 100 and selected variations thereof can be configured as a walk-up bar in public thoroughfares (e.g., college campuses, airports, train stations, shopping malls, etc.), or as a storefront business such as a café or restaurant. In one aspect of this embodiment, the QSR 100 includes multiple display cabinets 102 positioned above and behind a service bar 110. Each of the display cabinets 102 can hold multiple retail-sale packages 104 for multiple competitively-branded, single-category food products. For example, in the illustrated embodiment the display cabinets 102 hold an array of breakfast cereal boxes (e.g., a Cheerios® box, a Frosted Flakes® box, a Capt'n Crunch® box, etc.). Arranging the competitively-branded cereal boxes in the display cabinets 102 in plain view of the customers (not shown) provides the customers with an immediate sensory connection to the various menu items on offer.

Multiple storage bins 106 are positioned behind the service bar 110 and generally below the display cabinets 102. As described below, the storage bins 106 contain, among other things, bulk supplies of the various breakfast cereals displayed in the cabinets 102. When a customer places an order, an employee of the QSR 100 (referred to in one embodiment as a “Cereologists”) removes the selected cereals from the storage bins 106 to prepare the order. In one embodiment, the storage bins 106 can include dispensing apparatus configured to deliver a pre-determined amount of cereal into a carry-out or serving container. This feature facilitates accurate product proportioning and an efficient first-in/first-out rotation of the product contained in the storage bins 106.

A menu board 130 is positioned above and behind the service bar 110 adjacent to the display cabinets 102. In the illustrated embodiment, the menu 130 is divided into three different sections. A first menu section 132 (“Your Cereal. Your Way.”) allows customers to choose from a list of different competitively-branded cereals and have them prepared as they desire. The competitively-branded cereals can include cereals currently sold in supermarkets, as well as a variety of other cereals. These other cereals can include, for example, nostalgic names (e.g, Quisp®) and other discontinued cereals (e.g., Vanilla Capt'n Crunch®) that may no longer be available on the supermarket shelves. These cereals can also include specialty cereals, such as organic cereals and popular cereals from other countries. When ordering from this menu section, customers can create cereal mixes just the way they like them. Specifically, they can mix and match their favorite brand-name cereals in a single bowl and add one or more different toppings. Alternatively, they can mix various brand-name cereals together and purchase them in bulk in a small to-go bag (e.g., 3 scoops) or a large carry-out box (e.g., 6 scoops).

A second menu section 134 (“Your Cereal. Our Way.”) includes specialty cereal mixes created by the QSR 100. This menu section enables customers to experiment with both hot and cold cereal blends they may not have ever thought of, such as “Life Experience™” (i.e., Life® Cereal with almonds, honey, and topped with bananas). A third menu section 136 (“Your Cereal. A Whole New Way.”) offers various menu items that include cereal in creative ways. For example, in one embodiment this menu section can include smoothies (“Slurrealities™) made from different types of yogurt, cereal, fruit juice, etc. This menu section can also include various baked goods made from cereals, including cereal bars (“Cereality Bars™”) and snack mixes (“Cereality Bites™”). This section of the menu can also include various parfaits (“Parfaits Your Way™”) made with, for example, yogurt, cereal and fruit.

Many of the food items listed on the menu 130 are situated on or near the service bar 110 in plain view of the customers. For example, multiple different toppings 146 are arranged on the service bar 110 just to the left of an order station 112. The toppings can include, for example, sliced bananas, cinnamon apples, strawberries, raisins, sliced almonds, pumpkin seeds, Pop Rocks®, etc. Flavored milk crystals 144 can be placed next to the toppings 146 on the service bar 110. The milk crystals 144 can include various flavors, such as chocolate hazelnut, caramelized banana, red berry, etc. Parfaits 142 can be arranged in a display case 141 in a central portion of the service bar 110. As discussed above, the parfaits can include various flavors of yogurt combined with one or more different types of fruit, fruit juice, and/or branded cereal. Various cereal snack mixes 138 and cereal bars 140 can also be arranged in the display case 141 with the parfaits 142. The cereal snack mixes 138 can include various sweet and/or savory cereal mixes. For example, the cereal snack mixes 138 can include “Cinnamon-Oh-Man” (a mixture of cinnamon cereals, dried apples, raisins, etc.), “Tiki Torch Granola,” and “Honey Mustard Munch.” The cereal bars 140 can include, for example, “Raisin' the Roof Bran Snackin' Cake” made with Quaker Oats® and Quaker Bran Flakes®, and “S'mores Bar” made with Quaker Honey Graham Oh's®.

In addition to these cereal bars, in another embodiment of the QSR 100, customers can also order “customized” cereal bars. Customized cereal bars can include, for example, chewy granola bars and other types of bars made to order. In this regard, the QSR 100 can include a cereal bar pressing device (not shown) or similar system that combines the customer-selected ingredients together and presses them into a bar without an associated cooking process. Customers can select from a list of core ingredients (e.g, oats, fruit, nuts, chocolate chips, etc.) to suit their taste. Further, the customers can also select from various nutritive and non-nutritive additives and/or coatings to enhance the product.

Also illustrated in FIG. 1 are multiple viewing screens 170 (identified individually as a first viewing screen 170a and a second viewing screen 170b). As mentioned above, in one embodiment the viewing screens 170 can be configured to show animated features for viewing by customers. The animated features can include familiar “Saturday morning” cartoons and other subject matter often associated with cereal and/or the breakfast dining experience.

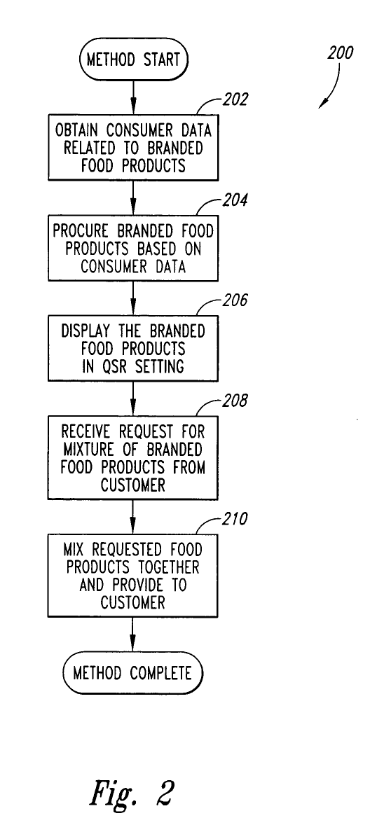

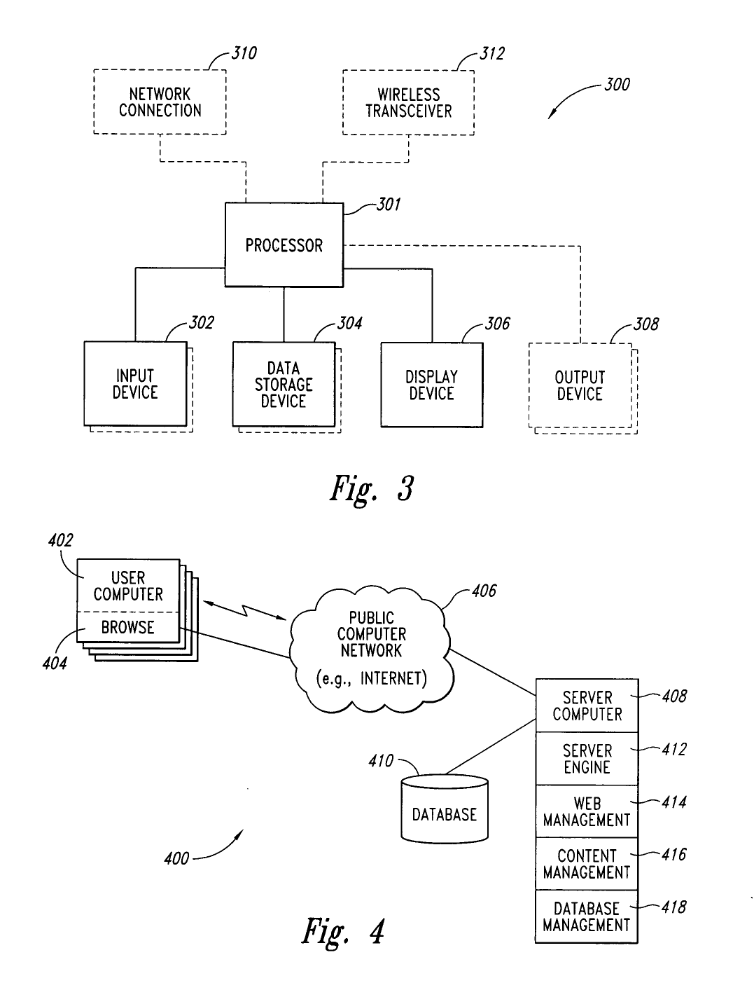

A customer (not shown) desiring to place an order at the QSR 100 approaches the order station 112 and places his or her order with an employee (also not shown) standing behind the service bar 110. After taking the order, the employee moves in the direction of customer flow and begins preparing the order. For example, if the customer orders a cereal combination, the employee removes the appropriate portions of the selected cereals from the storage bins 106 and mixes them together in a suitable bowl. In one embodiment, if the customer orders cereal “By the Bowl” for take-out or consumption at the QSR 100, the order can be prepared and served in a convenient carry-out container or bucket 150. The carry-out bucket 150 is described in more detail below with reference to FIG. 2. Alternatively, if the customer orders cereal “By the Bulk,” the order can be prepared in either a small (e.g., 3 scoops) to-go bag (not shown) or a large (e.g., 6 scoops) carry-out box 160. Various aspects of the carry-out box 160 are described in greater detail below with reference to FIG. 3.

After the employee has placed the selected cereals in the appropriate container, the employee can add whatever toppings 146 the customer ordered. Alternatively, the customer can choose to have the toppings placed in the container before the cereal, or in some other order of his or her choosing. In addition, the customer or employee can remove one or more of the parfaits 142, the cereal snack mixes 138, or the cereal bars 140 from the display case 141 to add to the order if desired. If the customer orders a smoothie (e.g., a “Slurreality™), the employee can prepare it using one or more of the blending devices 124 positioned behind the service bar 110. After taking any other steps necessary to complete the order, the employee moves toward a check-out station 114 to deliver the order to the customer.

If the customer wishes to consume the cereal immediately, the customer can take his or her cereal container over to a milk dispenser 118 and add one or more different types of milk. In the illustrated embodiment, the milk dispenser 118 can dispense various types of fresh dairy milk (e.g., whole, skim, or 2%) and/or various specialty milks such as soy milk. Alternatively, the customer may elect to not add milk right away, but instead take the cereal home for consumption at a later time.

In another aspect of this embodiment, the QSR 100 can include an interactive, stand-alone kiosk 148 with which customers can create unique cereal orders (i.e., “Invent-a-Blend”) and automatically send the orders to a QSR employee for preparation. Various aspects of the interactive kiosk 148 are described in greater detail below with reference to FIGS. 8A-8G.

### EXAMPLE OF A METHOD OF OPERATION

FIG. 2 is a flow diagram of a method 200 for providing competitively-branded, single-category food products in a QSR setting in accordance with an embodiment of the invention. In block 202, the method 200 obtains consumer data relating to competitively-branded food products (e.g., cereals). In this embodiment, “consumer data” can relate to, for example, which brands of cereal consumers prefer and which combinations of cereals and associated toppings they would be most inclined to purchase. In block 204, the method 200 procures the branded food products from a bulk provider or different manufacturers based on the consumer data obtained in block 202. For example, staying with the cereal embodiment, the method 200 procures the different brands of cereal from the various cereal manufacturers, such as General Mills, Kellogg's, etc. In block 206, the method 200 displays the branded food products in a QSR setting. For example, in the cereal embodiment, the method 200 could display the various types of competitively-branded cereal products to customers in a homey, kitchen-type setting. The displays can include various toppings that can be combined with the cereal products, as well as drinks, e.g., coffee, and other accompanying items such as smoothies (“Slurrealities™”), cereal bars, snack mixes, etc.

In block 208 the method 200 receives a request for a mixture of the competitively-branded food products from a customer. In block 210, the method 200 mixes the requested food products together and provides them to the customer in a convenient container (e.g., the carry-out bucket 150 described above with reference to FIG. 2). In the cereal embodiment, the customer can then add milk or other liquid (e.g., soy milk) to the cereal and consume it at the QSR location. Alternatively, the customer may take the mixture with them to enjoy later. After block 210, the method 200 is complete.

### EXAMPLE OF A SUITABLE DATA PROCESSING SYSTEM

Various aspects of the restaurants described above can be implemented or facilitated with use of a suitable computing system. These aspects include, for example, food ordering and customer data gathering. FIG. 3 and the following discussion provide a brief, general description of a computing environment suitable for use with the present invention. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer,” as used generally herein, refers to any of the above devices, as well as any data processor.

Various aspects of the invention can also be practiced in distributed computing environments, where tasks or modules are performed by remote processing devices which are linked through a communications network, such as a Local Area Network (“LAN”), Wide Area Network (“WAN”) or the Internet. In a distributed computing environment, program modules or sub-routines may be located in both local and remote memory storage devices.

Other aspects of the invention may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that some portions of the invention may reside on a server computer, while other portions may reside on a client computer. Further, data structures and data transmissions particular to aspects of the invention are also encompassed within the scope of the invention.

Referring to FIG. 3, one embodiment of the invention employs a computer 300 (e.g., a personal or portable computer, workstation, stand-alone kiosk, point-of-sale device, mobile phone, etc.) having one or more processors 301 coupled to one or more user input devices 302 and data storage devices 304. The computer 300 is also coupled to at least one output device, such as a display device 306, and one or more optional output devices 308 (e.g., a printer, a plotter, speakers, tactile or olfactory output devices, etc.). The computer 300 may be coupled to external computers, such as via an optional network connection 310, a wireless transceiver 312, or both.

The input devices 302 may include a keyboard and/or a pointing device such as a mouse. Other input devices are possible such as a microphone, joystick, pen, game pad, scanner, digital camera, video camera, and the like. The data storage devices 304 may include any type of computer-readable media that can store data accessible by the computer 300, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet (not shown in FIG. 3).

Aspects of the invention may be practiced in a variety of computing environments. FIG. 4, for example, illustrates a suitable computer system 400 having a web interface and one or more user computers 402. Each of the user computers 402 can include a browser program module 404 that permits the computer to access and exchange data with the Internet 406, including web sites within the World Wide Web portion of the Internet. The user computers 402 may be substantially similar to the computer 300 described above with reference to FIG. 3. User computers may include other program modules such as an operating system, one or more application programs (e.g., word processing or spreadsheet applications), and the like. The computers may be general-purpose devices that can be programmed to run various types of applications, or single-purpose devices optimized or limited to a particular function or class of functions.

At least one server computer 408, coupled to the Internet or World Wide Web (“Web”) 406, performs many or all of the functions for receiving, routing, and storing of electronic messages, such as web pages, audio signals and electronic images. While the Internet is shown, a private network, such as an intranet, may likewise be used herein. The network may have a client-server architecture in which one computer is dedicated to serving other client computers; or it may have other architectures, such as peer-to-peer, in which one or more computers simultaneously act as both servers and clients. A database 410 or databases, coupled to the server computer(s) 408, stores many of the web pages and content exchanged between user computers.

The server computer 408 can include a server engine 412, a web page management component 414, a content management component 416 and a database management component 418. The server engine 412 performs basic processing and operating-system-level tasks. The web page management component 414 handles creation and display or routing of web pages. Users may access the server computer 408 by means of a URL associated therewith. The content management component 416 handles most of the functions in the embodiments described herein. The database management component 418 performs storage and retrieval tasks with respect to the database, queries to the database, and storage of data such as cereal inventory, point-of-sale data, etc.

One skilled in the relevant art will appreciate that the concepts of the invention can be used in various environments other than location based environments or the Internet. In general, a display description may be in HTML, XML or WAP format, email format or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems and various other consumer products through which commercial or noncommercial transactions can be conducted. The various aspects of the invention described herein can also be implemented in or for an e-mail environment.

### EXAMPLES OF CUSTOMER KIOSK OR ON-LINE FUNCTIONALITY

FIGS. 5A-5G illustrate a series of screen displays 500a-g with which a customer can invent a unique blend of different foods, place an order for the blend, store the blend for later recall, and/or retrieve and order a previously stored blend. In the illustrated embodiment, the screen displays 500a-g relate to cereal blends and associated toppings. In other embodiments, however, the screen displays 500a-g and/or variations thereof can be used to invent blends of other foods and/or place orders for other foods.

In one embodiment, the screen displays 500 can be implemented with the interactive kiosk 148 described above with reference to FIG. 1. In other embodiments, all or a portion of the screen displays 500 (or variations thereof) can be implemented with a different computer system, such as a personal computer located in a customer's home or office which accesses the screen displays via a web server computer. In these other embodiments, the customer can place an order remotely for, e.g., a cereal blend, and then travel to a restaurant location to pick up or consume the order. Alternatively, the customer can place the order remotely and then have the order delivered to his or her home or office.

FIG. 5A illustrates a screen display 500a that enables a customer to select an existing cereal blend or create his or her own unique cereal blend (i.e., “invent-a-blend”). For example, the customer can select a first button 502a to select an existing cold cereal blend, or a second button 502b to select an existing hot cereal blend. Alternatively, the customer can select a third button 502c to create a cold cereal blend, or a fourth button 502d to create a hot cereal blend. On the other hand, if the customer instead preferred a parfait, he or she can select a fifth button 502e to create a parfait.

If the customer has used the kiosk 148 before to remotely create and/or order a menu item, the customer can select a sixth button 502f. This button brings up another screen display (not shown) which lists the customer's earlier creations. The customer can then select an earlier creation, and an order for that creation will be immediately transmitted to a remote operator (e.g., an employee of the QSR 100 of FIG. 1) for preparation.

If the customer desires to change a selection on the screen display 500a, the customer can do so by selecting a “Start Over” button 503. Once the customer has made his or her final selection from the screen display 500a, the customer can select a “Next” button 504 to proceed with the ordering process. For example, if the customer selects the third button 502c to “Create a COLD cereal blend” and then selects the Next button 504, this brings up the screen display 500b illustrated in FIG. 5B.

The screen display 500b enables the customer to select a quantity of cereal for purchase. For example, the user can select a first button 512a to order a “Bowl” (i.e., two scoops of cereal, one topping/mix-in, and choice of milk). Alternatively, the user can select a second button 512b for a “Kid's Bowl” (i.e., one scoop of cereal and choice of milk), a third button 512c for a bowl of “Cereality Granola,” and a fourth button 512d for a “Cereal Box” (i.e., 8 scoops of cereal). The customer can select a “Back” button 516 to return to the previous screen and change a portion of the order. After selecting the desired order size from the screen display 500b, the customer can select a “Next” button 514 to proceed with the ordering process. For example, if the customer selects the first button 512a to order a Bowl, this brings up the screen display 500c illustrated in FIG. 5C.

The screen display 500c enables the customer to select from multiple different, competitively-branded cereals to fill his or her Bowl. In the illustrated embodiment, the customer is allowed to select two scoops of cereal because he or she previously selected “Bowl” as the desired serving size, and a Bowl includes two scoops of cereal. The first cereal selection is made using a first group of selector buttons 522a, and the second selection is made using a second group of selector buttons 522b. An “Up” button 528a allows the customer to scroll up through the list of different cereals, and a corresponding “Down” button 528b lets the customer scroll down through the list. After the customer has selected the desired cereals, the customer can select a “Next” button 526 to proceed to the screen display 500d illustrated in FIG. 5D.

The screen display 500d enables the customer to select one or more toppings. Each of a multiple different toppings (e.g., almonds, raisins, bananas, etc.) is associated with a corresponding button 532. The customer can select a topping by clicking on the appropriate button. The customer can view additional toppings by selecting either a “Previous Toppings” button 538a or a “More toppings” button 538b. After one or more toppings have been selected, the customer can select a “Next” button 534 to proceed to the screen display 500e illustrated in FIG. 5E. Although the screen displays 500c and 500d of the illustrated embodiment include textual descriptions of the various cereals and toppings available, both of these screen displays can also or instead include graphics describing various aspects (e.g., brands, logos, etc.) of the offerings.

The screen display 500e enables the customer to complete his or her order. In the illustrated embodiment, the customer's order is displayed on the screen. After checking the order, the customer can select a Send button 542 to automatically send the order to a remote operator (e.g., an employee at a Point-of-Sale counter of the QSR 100) for preparation. Alternatively, the user can select a Send/Save button 544 that will additionally save the customer's order in an associated database from which the user can retrieve the order at a later date. On the other hand, if the customer desires to just save the order without placing it at this time, the customer can do so by selecting a Save button 546. Selecting either the Send/Save button 544 or the Save button 546 automatically brings up the screen display 500f illustrated in FIG. 5F.

The screen display 500f enables the customer to enter a unique code that will be associated with the customer's saved order. In this regard, the screen display 500f includes a graphical representation of a keyboard 552 with which the customer can enter a User ID in a display field 556. Once this has been done, the customer can select a “Next” button 554 to proceed to the screen display 500g illustrated in FIG. 5G. The screen display 500g is generally similar in structure and function to the display screen 500f, and can be used by the customer to enter a unique Password in a display field 566 in a similar manner. In the illustrated embodiment, the Password is used in conjunction with the User ID to ensure that only the originating customer has access to his or her stored orders.

The interactive kiosk 148 illustrated in FIG. 1, and the related screen displays 500a-g described above with reference to FIGS. 5A-5G, can be utilized in one embodiment as follows. First, a customer approaches the kiosk 148 and inputs his or her order (e.g., a combination of various cereals and toppings) in the manner described above with reference to FIGS. 5A-5G. Once the customer has input the order, the order is automatically transmitted to an output device (e.g., a point-of-sale device) located at the service bar 110 (FIG. 1). In one embodiment, the output device can include a paper printer that outputs a printed recipe for the desired food combination. At this time, one of the QSR staff (e.g. a “Cerealologist”) can prepare the order based on the printed output. In this manner, the Cerealologist can be preparing the customer's order as the customer makes their way from the kiosk 148 to the check-out station 114 (FIG. 1). When the customer arrives, their order is ready to go. In this embodiment, the customer can pay for the order at the check-out station 114. In another embodiment, however, the customer can pay for the order at the kiosk 148 via suitable payment functionality (e.g., a credit card reader, a bill and/or coin slot, a user interface configured to receive a customer account no., etc.)

In another embodiment, the kiosk 148 can transmit the customer's order to a automatic food-preparing apparatus (not shown) instead of a point-of-sale device. In one aspect of this embodiment, the food-preparing apparatus can be configured to automatically prepare the customer's order in response to receiving an appropriate signal from the kiosk 148. In addition, in this embodiment the apparatus can also package the customer's order and dispense it proximate to the point-of-sale.

The kiosk 148 can also be configured to provide customers with recommended menu items and combinations, and nutritional information about various menu choices. For example, in one embodiment, the kiosk 148 can provide customers with recommended menu items tailored to fit specified dietary and/or nutritional preferences or restrictions.

### EXAMPLES OF POINT-OF-SALE DEVICE FUNCTIONALITY

FIGS. 6A-6D illustrate various point-of-sale screen displays 610a-d configured in accordance with an embodiment of the invention. In this embodiment, the screen displays 610a-d can be presented in sequential order to a point-of-sale staff or cashier to facilitate taking a customer's order at the QSR 100 described above with reference to FIG. 1. In FIG. 6A, a screen display 610a lists various food product options available to the customer. These options can include, for example, one or two scoops of a particular type of cereal, fruit toppings, cereal bars, parfaits, liquids to mix with the cereal (e.g., milk, soy, etc.), and drinks such as coffee and tea. If the cashier selects a “2 SCOOP” button 602, the screen display 610b of FIG. 6B is displayed.

As FIG. 6B illustrates, the screen display 610b includes a list of cereals from which the customer can choose. If, for example, the customer tells the cashier that he or she desires Apple Jacks and Golden Grahams, then the cashier accordingly selects an “Apple Jacks” button 606 and a “Golden Grahams” button 608. Doing so generates the display screen 610c illustrated in FIG. 6C.

The display screen 610c illustrates the various types of fruit and other toppings available. In this particular embodiment, one topping is free with a two scoop cereal order. If, for example, the customer desires dried apples, the cashier selects a “Dried Apple” button 612. This selection generates the screen display 610d illustrated FIG. 6D. The display screen 610d shows the cashier the customer's order and the associated price.

Point-of-sale devices configured in accordance with the present invention can include other functionalities in addition to those described above. For example, such devices can also analyze inventory status and costs of goods. Further, the devices can also track baked goods and other products in order of usage/sale.

### EXAMPLE OF A ROUTINE FOR RECEIVING AND ANALYZING DATA

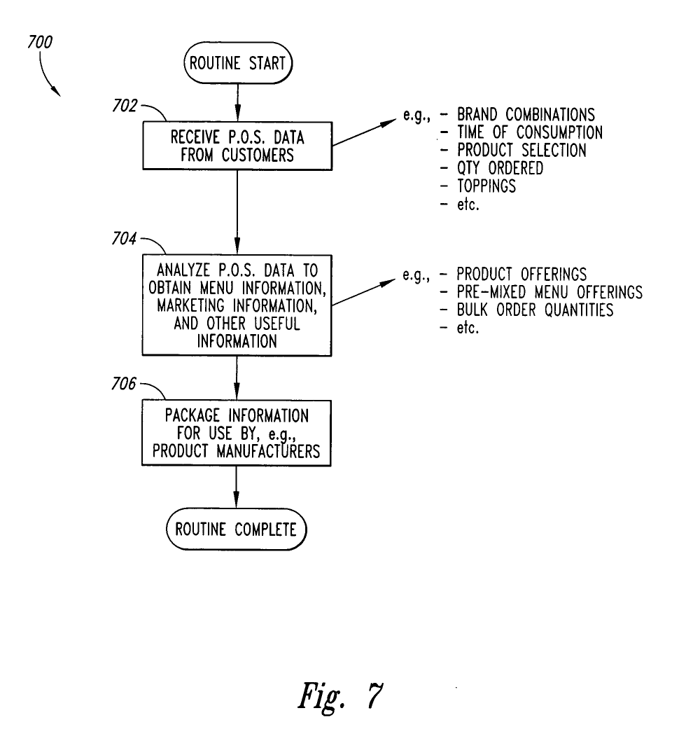

FIG. 7 is a flow diagram of a routine 700 for receiving and analyzing customer point-of-sale data in accordance with an embodiment of the invention. In block 702, the routine 700 receives raw point-of-sale data from customers. In one embodiment, the raw data can include information about customers' eating habits. For example, the raw data can include information about the types of branded food products (e.g., what types of cereals and cereal combinations) the customers order, the types of other food products (e.g., breakfast cereals, breakfast bars, smoothies, etc.) the customers order, the time when customers place their orders (time of day, day of week, etc.), the quantities of products ordered, as well as other useful information. In addition, the raw point-of-sale data can also include information about, among other things:
Sales of custom cereal blends (e.g., customer-invented blends) versus store-offered blends;
Effectiveness of promotions such as advertising and coupons;
Merchandize sales;
Product combinations including cereal combinations, cereal and topping combinations, cereal and drink combinations, etc;
The effects of weather on sales and product selections;
Single versus multiple person orders;
Customer profiles including repeat customer trends;
Catering orders;
Phone orders; and
Patterns of bulk orders.

In block 704, the raw data received in block 702 is analyzed or “mined.” In this embodiment, the data can be mined to determine particular customer trends, such what types of independently-branded food products (e.g., cereals, cereal combinations, toppings, etc.) customers desire. The data can be mined to provide other information as well, including, for example, marketing approaches, product offerings (e.g., different “premixed” product offerings), and bulk quantities of particular items to warehouse in view of customer demand.

In block 706, the routine 700 packages the point-of-sale data in reports and/or other useful forms for use by QSR operators and other entities. In this regard, the data format is completely customizable. For example, it can be organized in a database or as a narrative text. Further, the various types of data can be merged to provide useful information. For example, weather data can be merged with sales data to determine if warm weather drives higher sales of cold cereal, or if cold weather drives higher sales of hot cereal.

In one embodiment, the data can be provided to bulk product suppliers (e.g., cereal manufacturers) for use in determining what types of products to offer the home consumer as well as particular marketing strategies. The data can be transmitted via a network (e.g., the Internet), or sent as a hard copy. In another embodiment, third-party users can obtain the data in real-time by accessing a password-protected website or other electronic location. After block 706, the routine 700 is complete.

Unless the context clearly requires otherwise, throughout the foregoing description and the associated examples, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of various embodiments of the invention is not intended to be exhaustive or to limit the invention to the precise form disclosed. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in the above Detailed Description using the singular or plural number may also include the plural or singular number respectively.

The teachings of the invention provided herein can be applied to systems other than the system described herein. Similarly, the elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. As noted above, particular terminology used when describing certain features or aspects of the invention should not be taken to imply that the terminology is being redefined herein to be restricted to any specific characteristics, features, or aspects of the invention with which that terminology is associated. Accordingly, the actual scope of the invention encompasses not only the disclosed embodiments, but also all equivalent ways of practicing or implementing the invention.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

While certain aspects of the invention are presented below in certain claim forms, the inventors contemplate the various aspects of the invention in any number of different claim forms. For example, while one or more aspects of the invention may be recited as embodied in a computer-readable medium, other aspects may likewise be embodied in a computer-readable medium. Accordingly, the inventors reserve the right to add additional claims after filing the application to pursue such additional claim forms for other aspects of the invention.

While certain aspects of the invention are presented below in certain claim forms, the inventors contemplate the various aspects of the invention in any number of different claim forms. For example, while one or more aspects of the invention may be recited as embodied in a computer-readable medium, other aspects may likewise be embodied in a computer-readable medium. Accordingly, the inventors reserve the right to add additional claims after filing the application to pursue such additional claim forms for other aspects of the invention.

1. A method for obtaining consumer data relating to cereal, the method comprising:
providing a menu to a customer in a quick-serve restaurant setting, the menu including at least one menu item that allows the customer to select two different, competitively-branded breakfast cereals from a list of competitively-branded breakfast cereals;
receiving a request from the customer associated with the menu item, wherein the request relates to a first selection of a first one of the competitively-branded cereals and a second selection of a second one of the competitively-branded breakfast cereals, and wherein the first competitively-branded breakfast cereal is made by a first manufacturer and the second competitively-branded breakfast cereal is made by a second manufacturer;
in response to receiving the request from the customer, recording information related to the request in a database, the recorded information including at least a first identifier for the first competitively-branded breakfast cereal and a second identifier for the second competitively-branded breakfast cereal; and
providing at least a portion of the recorded information to a third party user.

2. The method of claim 1 wherein receiving a request from the customer includes receiving a request for a first cereal from a first cereal manufacturer, a second cereal from a second cereal manufacturer, and a predetermined quantity of a topping.

3. The method of claim 1 wherein recording information related to the request includes recording the time of the request.

4. The method of claim 1 wherein recording information related to the request includes recording the day of the request.

5. The method of claim 1 wherein the request for the menu item is a first request for a first menu item, and wherein the method further comprises:
receiving a second request from the customer for a second menu item; and
recording information related to the second request in the database.

6. The method of claim 1 wherein the request for the menu item is a first request for a first menu item, and wherein the method further comprises:
receiving a second request from the customer for a second menu item, the second menu item including cereal; and
recording information related to the second request in the database.

7. The method of claim 1 wherein recording information related to the request includes recording a first quantity of the first competitively-branded cereal and a second quantity of the second competitively-branded cereal.

8. The method of claim 1 wherein providing a menu to a customer includes displaying the menu on a display screen of an interactive, stand-alone kiosk, and wherein receiving a request from the customer includes receiving an electronic request from the stand-alone kiosk in response to user input.

9. The method of claim 1 wherein receiving a request from a customer includes receiving a request via a computer network.

10. The method of claim 1 wherein providing at least a portion of the recorded information to a third party user includes providing at least a portion of the recorded information to a cereal manufacturer.

11. The method of claim 1 wherein receiving a request from the customer includes receiving a request for a first cereal from a first cereal manufacturer and a second cereal from a second, different cereal manufacturer, and wherein providing at least a portion of the recorded information to a third party user includes providing at least a portion of the recorded information to the first cereal manufacturer.

12. The method of claim 1, further comprising:
in response to receiving the request from the customer, combining a first portion of the first competitively-branded breakfast cereal with a second portion of the second competitively-branded breakfast cereal in a carry-out container; and
presenting the carry-out container to the customer in exchange for payment.

13. The method of claim 1, further comprising, in response to receiving the request from the customer, inputting the first selection of the first competitively-branded cereal and the second selection of the second competitively-branded breakfast cereal into a point-of-sale device, wherein recording information related to the request in a database includes recording the information in a database operably connected to the point-of-sale device.

14. The method of claim 1 wherein recording information related to the request in a database includes recording a first portion of information in the database, and wherein the method further comprises:
compiling the first portion of information recorded in the database with a second portion of information previously recorded in the database; and
analyzing the compiled information to obtain information about cereal consumption trends.

15. The method of claim 1 wherein recording information related to the request in a database includes recording a first portion of information in the database, and wherein the method further comprises:
compiling the first portion of information recorded in the database with a second portion of information previously recorded in the database;
analyzing the compiled information to obtain information about cereal consumption trends; and
generating a report that includes the information about cereal consumption trends.

16. The method of claim 1 wherein recording information related to the request in a database includes recording a first portion of information related to a first customer, and wherein the method further comprises:
compiling the first portion of information with a second portion of information related to a second customer, wherein providing at least a portion of the recorded information to a third party user includes providing information related to the first and second customers to the third party user.

17. The method of claim 1 wherein recording information related to the request in a database includes recording a first portion of information in the database, and wherein the method further comprises:
compiling the first portion of information recorded in the database with a second portion of information previously recorded in the database; and
analyzing the compiled information to obtain cereal marketing information.

18. The method of claim 1 wherein the first identifier is a first brand name of the first competitively-branded cereal, and the second identifier is a second brand name of the second competitively-branded cereal.

19. The method of claim 1, further comprising:
retrieving the recorded information from the database; and
packaging the recorded information before providing at least a portion of the recorded information to the third party user.

20. A method for obtaining consumer data relating to cereal, the method comprising:
providing a quick-serve restaurant, the quick-serve restaurant offering multiple competitively-branded breakfast cereals;
receiving a request from a customer for a portion of at least one of the competitively-branded breakfast cereals; and
in response to receiving the request from the customer, recording information related to the request in a database, the recorded information including at least the brand name of the first competitively-branded breakfast cereal.

21. The method of claim 20 wherein recording information related to the request in a database further includes recording a time of the request.

22. The method of claim 20 wherein recording information related to the request in a database further includes recording a quantity of the portion of the at least one competitively-branded cereal.

23. The method of claim 20 wherein recording information related to the request in a database further includes recording customer identification information.

24. The method of claim 20 wherein receiving a request from a customer includes receiving a request for a menu item composed of a first competitively-branded breakfast cereal combined with a second competitively-branded breakfast cereal, and wherein recording information related to the request in a database includes recording the brand names of the first and second competitively-branded breakfast cereals.

25. The method of clam 20 wherein receiving a request from a customer includes receiving an order from a stand-alone kiosk with which the customer placed the order.

26. The method of claim 20, further comprising providing at least a portion of the recorded information to a third party user.

27. The method of claim 20, further comprising providing at least a portion of the recorded information to a cereal manufacturer.

28. The method of claim 20, further comprising, in response to receiving the request from the customer, inputting information related to the request into a point-of-sale device, wherein recording the information related to the request in a database includes recording the information in a database operably connected to the point-of-sale device.

29. The method of claim 21 wherein recording information related to the request in a database includes recording a first portion of information in the database, and wherein the method further comprises:
compiling the first portion of information recorded in the database with a second portion of information previously recorded in the database; and
analyzing the compiled information to obtain cereal data based on the first and second portions of recorded information.

30. A computer-readable medium containing instructions configured to cause a computer to compile point-of-sale data by a method comprising:
receiving a first customer order, the first customer order including:
first cereal information; and
second cereal information;
in response to receiving the first customer order, recording the first cereal information and the second cereal information in a database;
receiving a second customer order, the second customer order including:
third cereal information; and
fourth cereal information;
in response to receiving the second customer order, recording the third cereal information and the fourth cereal information in the database; and
generating reporting data associated with the first cereal information, the second cereal information, the third cereal information, and the fourth cereal information.

31. The computer-readable medium of claim 30 wherein the method further comprises outputting reporting data associated with the first cereal information, the second cereal information, the third cereal information, and the fourth cereal information.

32. The computer-readable medium of claim 30 wherein receiving a first customer order includes receiving a first selection of a first cereal by a first manufacturer and receiving a second selection of a second cereal by a second, different manufacturer.

33. The computer-readable medium of claim 30, further comprising recording a time of day of the first customer order in the database.

34. The computer-readable medium of claim 30, further comprising recording a date of the first customer order in the database.

35. A system for collecting consumer data relating to cereal, the system comprising:
means for offering multiple competitively-branded breakfast cereals to customers in a quick-serve restaurant setting;
means for receiving a request from a customer for a portion of at least one of the competitively-branded breakfast cereals;
means for recording information relating to the at least one competitively-branded cereal in response to receiving the request from the customer, the recorded information including at least a cereal identifier; and
means for providing at least a portion of the recorded information to a third party user.

36. The system of claim 35 wherein the means for receiving a request from a customer include means for receiving a request for a first competitively-branded cereal mixed with a second competitively-branded cereal.

37. The system of claim 35 wherein the means for receiving a request from a customer include means for receiving a request for a first competitively-branded cereal mixed with a second competitively-branded cereal, and wherein the means for recording information include means for recording information relating to the first and second competitively-branded cereals.

38. The system of claim 35 wherein the means for providing at least a portion of the recorded information to a third party user include means for outputting a report.

39. A computer-implemented method for distributing cereal, the method comprising:
displaying a menu to a customer on a display screen, the menu including multiple competitively-branded breakfast cereals;
receiving, based on customer input, a customer order identifying a first competitively-branded breakfast cereal to be mixed with a second competitively-branded breakfast cereal; and
transmitting the customer order for preparation.

40. The method of claim 39 wherein transmitting the customer order for preparation includes transmitting the customer order to a service bar, and wherein the method further comprises;
preparing the customer order at the service bar; and
delivering the customer order to the customer.

41. The method of claim 39 wherein displaying a menu on a display screen includes displaying a menu on a display screen of a kiosk.

42. The method of claim 39 wherein displaying a menu on a display screen includes displaying a menu on a display screen of a personal computer, and wherein transmitting the customer order for preparation includes transmitting the customer order via the Internet.

43. The method of claim 39 wherein displaying a menu on a display screen includes displaying a menu on a display screen of a kiosk in a restaurant, and wherein transmitting the customer order for preparation includes transmitting the customer order from the kiosk to a service bar in the restaurant, and wherein the method further comprises;
preparing the customer order at the service bar; and
delivering the customer order to the customer.

44. A screen display for remotely ordering cereal, the screen display comprising:
a first identifier for display corresponding to a first competitively-branded breakfast cereal;
at least a second identifier for display corresponding to a second competitively-branded breakfast cereal; and
a display portion for receiving a selection from a customer corresponding to at least one of the first and second competitively-branded breakfast cereals.

45. The screen display of claim 44, further comprising means for receiving a selection from the customer for a topping to be combined with the at least one of the first and second competitively-branded breakfast cereals.

46. The screen display of claim 44 wherein the display portion includes a kiosk.

47. The screen display of claim 44 wherein the display portion includes a remote user-computer.

48. The screen display of claim 44, further comprising means for storing a customer-selected cereal blend in a database.
